(19) United States
(12) Patent Application Publication
(10) Pub. No.: US 2024/0097469 A1
(43) Pub. Date: Mar. 21, 2024

(54) SYSTEM AND METHOD FOR ON-SITE DETERMINATION OF CHARGING CURRENT FOR A BATTERY

(71) Applicant: Hong Kong Applied Science and Technology Research Institute Co., Ltd., Shatin (HK)

(72) Inventors: Pau Yee LIM, Ma On Shan (HK); Chun Yiu LAW, Shatin (HK); Yuanming ZHANG, Shatin (HK); Chun Lun AU, Shatin (HK)

(21) Appl. No.: 18/089,878

(22) Filed: Dec. 28, 2022

Related U.S. Application Data
(60) Provisional application No. 63/408,822, filed on Sep. 21, 2022.

(51) Int. Cl. H02J 7/00

(52) U.S. Cl. CPC H02J 7/007; H02J 7/00032; H02J 7/0048

(57) ABSTRACT

A method for charging a battery, which includes the steps of acquiring real-time information about the battery; receiving on-site input from a user, the on-site input comprising at least one of a user available time in which the battery is to be charged and a target State of Charge (SoC) to which the battery is to be charged; by using a capacity charging model of the battery, calculating a charging current for the battery based on the on-site input and the real-time information; charging the battery using the calculated charging current during a charging period to fulfill the user's energy requirement; and calibrating the capacity charging model based on information of the battery gathered during the charging period. The invention provides an adaptive battery charging method and system that decides an optimal charging current for batteries in view of on-site user commands inputted to the battery charger.

### FIELD OF INVENTION

This invention relates to systems and methods for determining a charging current of a battery.

### BACKGROUND OF INVENTION

Battery-powered devices are used widely in both daily life and professional work environment, ranging from vehicles, power tools, computing devices, to kids' toys. Due to the limitations of current battery technologies, at any given form factor capacity of the battery is far from ideal, and users of the battery-powered devices often worry about state of charge (SoC) of batteries. Some users even develop the pattern of charging the battery whenever charging facility is available. Generally, there are two fixed charging current modes for batteries, namely a slow-charging mode and a fast-charging mode. The slow-charging mode is suitable for scenarios where there is less or no time constraint in charging, so that the charging can be conducted at a slow pace, which is beneficial to cycle life of the battery. However, for most other scenarios, the slow-charging mode causes inefficient utility of the battery and time, and therefore backup battery packs or even backup battery-powered devices are necessary.

On the other hand, the fast-charging mode applies a larger current to charge the battery as compared to the slow-charging mode. With the increased current, the charging time can be shortened, but it causes degradation in the battery system in which the cycle life of batteries will be shortened. Some fast-charging schemes further allow adjustments to the charging rate. For example, the value of charging current may be modified, and higher current gives a faster charging rate, while a lower current gives a slower charging rate. In another example, different charging patterns over time can be designed. Charging at a fast charging rate at short time slots results in enhancement of time utility efficiency. In contrast, charging at a slow charging rate at long time slots results in reduced battery life impact. However, there is no “all around” charging scheme as each scheme has its pros and cons for a particular charging scenario, and there is a tradeoff between battery life and time utility/efficiency.

### SUMMARY OF INVENTION

Accordingly, the present invention, in one aspect, is a method for charging a battery, which includes the steps of acquiring real-time information about the battery; receiving on-site input from a user, the on-site input comprising at least one of a user available time in which the battery is to be charged and a target State of Charge (SoC) to which the battery is to be charged; by using a capacity charging model of the battery, calculating a charging current for the battery based on the on-site input and the real-time information; charging the battery using the calculated charging current during a charging period; and calibrating the capacity charging model based on information of the battery gathered during the charging period.

In some embodiments, the capacity charging model is a programmable model of the battery which is built based on a plurality of charging profiles of the battery.

In some embodiments, the plurality of charging profiles of the battery contains a constant voltage (CV) mode capacity profile, and a constant current (CC) mode voltage profile. It is preferred that in the capacity charging model, the CC mode capacity profile is ahead of the CV mode voltage profile in time.

In some embodiments, the step of acquiring real-time information about the battery further includes recording the following information of the battery: real-time SoC and real-time voltage.

In some embodiments, the capacity charging model contains a plurality of capacity-time correlations each defined under a condition including a CC mode current and a CV mode voltage;

In some embodiments, the plurality of capacity-time correlations is described by a set of parameters that are derived from the plurality of charging profiles of the battery.

In some embodiments, the charging current is for a CC charging stage of the battery according to the on-site input. The step of calculating a charging current for the battery based on the on-site input and the real-time information, further includes the steps of: identifying, from a plurality of capacity-time correlations in the capacity charging model, an optimal correlation that meets the user available time and/or the target SoC; and choosing an optimal current that is associated with the optimal correlation as the charging current.

In some embodiments, each one of the plurality of capacity-time correlations is further associated with a charging voltage for a CV charging stage of the battery.

In some embodiments, the step of calibrating the capacity charging model further includes the steps of recalling, from a memory device, one or more recent charging profiles which are associated with recent charging cycles and stored in the memory device; conducting an analysis to the one or more recent charging profiles to identify a set of updated parameters for the capacity charging model; and calibrating the capacity charging model using the set of updated parameters.

In some embodiments, the one or more recent charging profiles includes latest charging profiles of the battery gathered during the charging period which are stored to the memory device after the step of charging the battery using the calculated charging current during a charging period.

In some embodiments, the one or more recent charging profiles further contains previous charging profiles of the battery gathered during charging periods associated with previous charging cycles of the battery.

In some embodiments, the analysis contains a non-linear regression analysis.

According to another aspect of the invention, there is provided a system for charging a battery. The system includes one or more processors; a battery charging circuit connected to the one or more processors and adapted to connect to the battery; a user inputting means connected to the one or more processors, and a memory storing computer-executable instructions that, when executed, cause the one or more processors to perform a method. The method includes the following steps: acquiring real-time information about the battery; receiving on-site input from a user via the user inputting means, the on-site input comprising at least one of a user available time in which the battery is to be charged and a target State of Charge (SoC) to which the battery is to be charged; by using a capacity charging model of the battery, calculating a charging current for the battery based on the on-site input and the real-time information; charging the battery by controlling the battery charging unit to use the calculated charging current during a charging period; and calibrating the capacity charging model based on information of the battery gathered during the charging period.

According to yet a further aspect of the invention, there is provided a non-transitory computer readable medium, comprising executable instructions that, when executed by at least one processor, direct the at least one processor to perform a method. The method includes the following steps: acquiring real-time information about the battery; receiving on-site input from a user via the user inputting means, the on-site input comprising at least one of a user available time in which the battery is to be charged and a target State of Charge (SoC) to which the battery is to be charged; by using a capacity charging model of the battery, calculating a charging current for the battery based on the on-site input and the real-time information; charging the battery by controlling the battery charging unit to use the calculated charging current during a charging period; and calibrating the capacity charging model based on information of the battery gathered during the charging period.

One can see that exemplary embodiments of the invention provide an adaptive battery charging method and system that decides an optimal charging current for batteries in view of on-site user commands inputted to the battery charger. The optimal charging current is not fixed, but it is adjustable even for a same battery so that the most appropriate charging current can be chosen for each specific charging target as desired by the user in each charging cycle. The charging method balances the battery cycle life and the charging efficiency, while sticking to the user available time and target SoC specified by the user. This is achieved by inputting the requirements provided by the user on-site to a capacity charging computational model (CCCM) that is based on charging profiles of a particular battery. The CCCM is further self-calibrated by the battery charging system using recent charging profiles on a periodic schedule. In this way, any change in battery condition (e.g., performance deterioration as cycle life accumulates) can be taken into consideration to update the CCCM, and future charging optimization can be made on a relatively accurate basis.

The battery charging system and method according to embodiments of the invention are suitable for any types of battery with a fast charge ability, for example lithium-ion batteries and aqueous-based batteries. Exemplary applications of the battery charging system and method are also not limited, yet they are particularly suitable for charging systems with periodic/regular usage schedule, e.g., AGV (Automated Guided Vehicle), AMR (Autonomous Mobile Robot), and e-scooter. The battery charging method does not require any dedicated, new hardware in the charging system. Rather, the hardware can be typical ones for battery chargers, and for example new firmware can be installed in the battery management system module of battery chargers to achieve proposed charging methods.

The foregoing summary is neither intended to define the invention of the application, which is measured by the claims, nor is it intended to be limiting as to the scope of the invention in any way.

### BRIEF DESCRIPTION OF FIGURES

The foregoing and further features of the present invention will be apparent from the following description of embodiments which are provided by way of example only in connection with the accompanying figures, of which:

FIG. 1 is the illustration of a battery charging system according to an embodiment of the invention.

FIG. 2 shows the main steps of a battery charging method according to an embodiment of the invention.

FIG. 3 depicts the process flow of the microcontroller/firmware in a battery charging system in executing the method in FIG. 2.

FIG. 4a shows the charging profiles of an exemplary battery in CC and CV stages.

FIG. 4b shows computed and measured correlations between capacity and time at different charging currents in an exemplary CCCM.

FIG. 4c is a flow chart showing the steps of determining an optimal charging current at CC stage using CCCM, according to an embodiment of the invention.

FIG. 5 illustrates the self-change of charging profiles over time for an exemplary battery.

FIG. 6 is a flow chart showing the steps of updating the CCCM based on recent charging profiles of a battery, according to an embodiment of the invention.

FIG. 7a shows the comparison between an original correlation and an updated correlation of capacity-time for an exemplary battery.

FIG. 7b shows the comparison between an original correlation and an updated correlation of time-voltage for the battery in FIG. 7a.

FIG. 8 illustrates the comparison in charging efficiency between a method according to a preferred embodiment and a conventional slow-charging method.

FIG. 9 illustrates the comparison in cycle life between a method according to a preferred embodiment and a conventional fast-charging method.

FIG. 10 shows comparisons between computed and measured capacity-time correlations based on various CC mode charging currents and/or cut-off voltages in an exemplary CCCM.

FIG. 11a shows various voltage curves as charging profiles for CC-mode charging in an exemplary CCCM, where these voltage curves are based on different cut-off voltages but the same CC mode charging current.

FIG. 11b shows various voltage curves as charging profiles for CC-mode charging in an exemplary CCCM, where these voltage curves are based on different CC mode charging currents.

FIG. 12a shows various capacity curves as charging profiles for CV-mode charging in an exemplary CCCM, where these voltage curves are based on the same cut-off voltage but different CC mode charging currents.

FIG. 12b shows various capacity curves as charging profiles for CV-mode charging in another exemplary CCCM, where these voltage curves are based on the same cut-off voltage but different CC mode charging currents.

### DETAILED DESCRIPTION

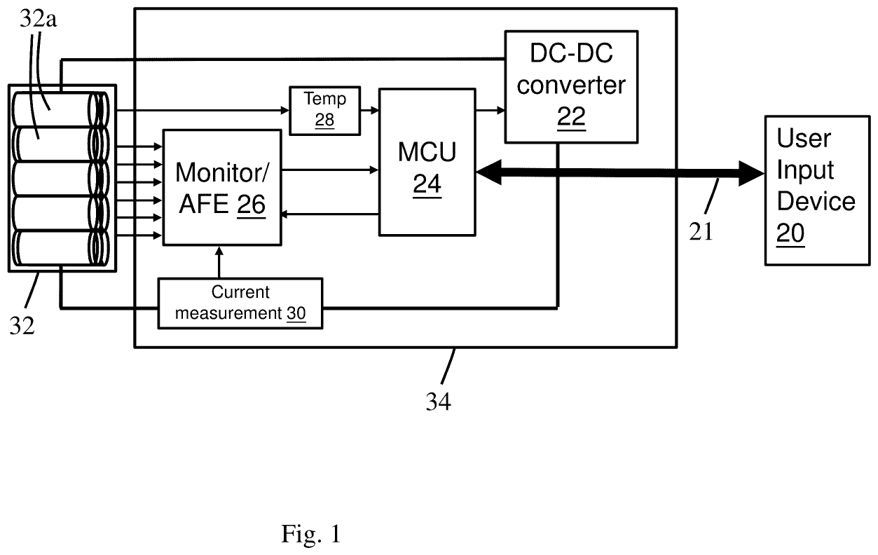

FIG. 1 depicts, according to a first embodiment of the invention, a battery charging system that includes a battery 32 containing multiple battery cells 32a, and a battery charging module 34 coupled to the battery 32. In particular, the battery charging module 34 contains an AFE (Analog Front End) 26 that is used as a monitoring device for acquiring certain information of the battery 32 such as the SoC, the voltage, and cycle life, either for the battery 32 as a whole, or for individual cells 32a in the battery 32. The AFE 26 is connected to a MCU (Microprogrammed Control Unit) 24 and in communication with the latter. Also coupled between the MCU 24 and the battery 32 are a temperature sensor 28 and a current measurement module 30 which for example is a current sensor. The AFE 26, the temperature sensor 28 and the current measurement module 30 all act as inputs to the MCU 24 to provide real-time information about the battery 32 to the MCU 24. The MCU 24 further connects, via a communication link 21, to a user input device 20 that is adapted to accept user inputs for example for setting a particular charging target for the battery 32. To enable the charging control, the MCU 24 is connected to a DC-DC converter 22 which, upon receiving charging command signals from the MCU 24, is adapted to convert an DC power from a power supply (not shown) at a first voltage to an DC power at a second voltage that is compatible with the battery 32 and that can be used to charge the battery 32. The power supply can be any DC power source or AC source (with AC-DC conversion) as appreciated by persons skilled in the art.

The battery 32 can be any type of battery or battery pack that supports fast charging. Examples of the battery 32 includes lithium batteries, lithium-ion batteries (LIB), and aqueous zinc-ion batteries (ZIB). The battery cells 32a within the battery 32 can be connected in parallel, series, or in combination of parallel and series connections, so that a desired output voltage and capacity of the battery 32 can be achieved. The components mentioned above that are part of the battery charging module 34 are also well-known to those skilled in the art so they will not be described in any further details here. The battery charging module 34 can either be fixedly connected to the battery 32, for example in the case of a mobile power station that has a built-in battery and an AC inlet, or be removably connected to the battery 32, for example in the case of a power tool battery pack and its corresponding battery pack charger.

The user input device 20 can be any types of inputting devices, and it can be either located physically on the battery charging module 34 or remote from the battery charging module 34. In the example of the mobile power station, the user input device 20 can be a touch screen or a keypad on the housing of the mobile power station. In the example of a standalone battery charger that has wireless communication capability, the user input device 20 can be the user's tablet or mobile phone that remotely transmits input commands from the user to the charger. In the example of an electric or hybrid vehicle, the user input device 20 can be the center console of the vehicle.

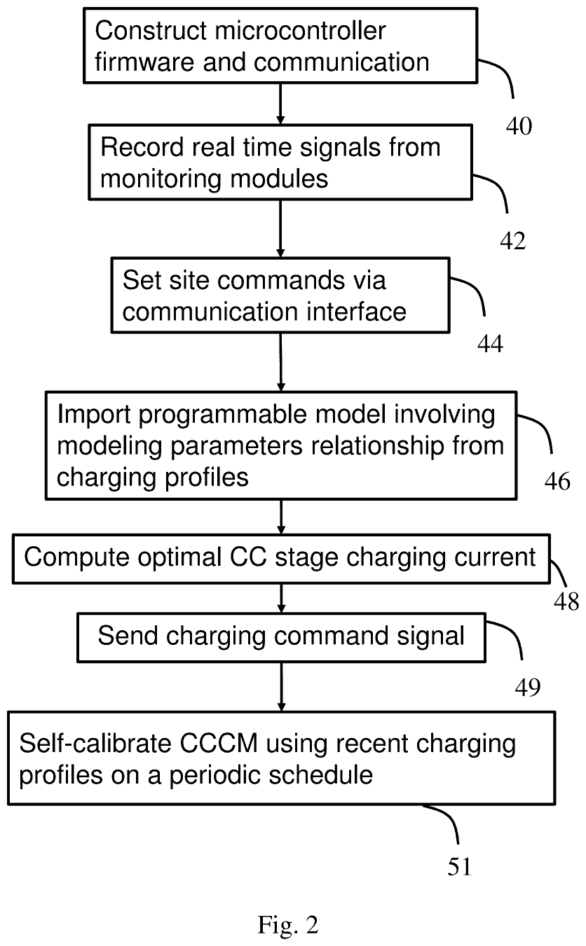

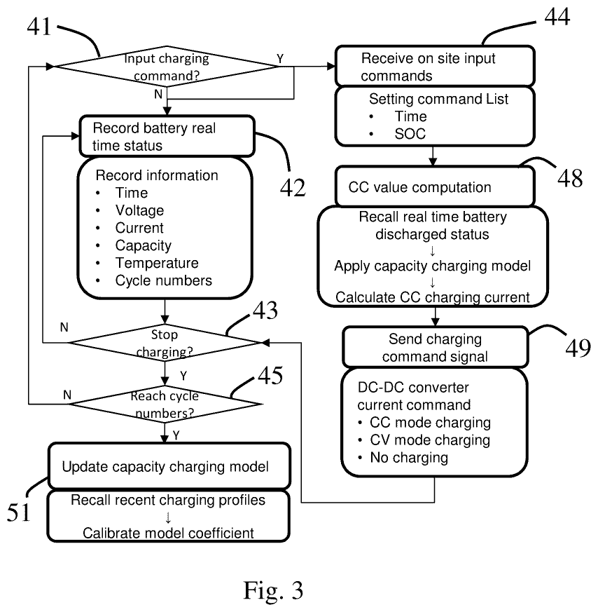

Turn to FIG. 2, which shows the main steps of an adaptive battery charging method according to an embodiment of the invention. Descriptions of these steps will be made with references to hardware components shown in FIG. 1, but it should be noted that the method in FIG. 2 is limited to be performed by the battery charging system in FIG. 1. Instead, the method in FIG. 2 may be implemented by other battery charging systems having configurations different from that shown in FIG. 1. Using the battery charging system in FIG. 1 for example, the method is centrally executed by the MCU 24, but in some steps other components are also involved either as inputs to the MCU 24 for battery information, or as the target of control (i.e., the battery 32). In this regard, FIG. 3 further provides details of the execution flow of the MCU 24 in performing the method in FIG. 2.

The method starts in Step 40, in which the firmware/software in the battery charging system is configured in a memory (not shown) located internal or external to the MCU 24. The firmware/software contains executable instructions by the MCU 24 to carry out the method, and it is pre-installed in factory when the battery charging system is manufactured. Also in Step 40, the communication link 21 between the MCU 24 is established, for example by initializing appropriate communication protocols, handshaking, or it is simply ready once the MCU 24 is energized.

After the initialization of the battery charging system is completed, the system is ready to charge the battery 32. Next, in Step 42 the battery information is continuously collected by the MCU 24 on a real-time basis, from the various components in FIG. 1 as mentioned above. Although not shown in FIGS. 2-3, Step 42 may be executed even when the battery 32 is not being charged, for example when it is idle or is discharging. An example of the monitoring of the battery status of the battery 32 during discharging is when both the discharging circuit and charging circuit are integrated with the battery 32 (e.g. on an electric vehicle). As shown in FIG. 3, information collected by the MCU 24 from the battery 32 may include one or more of time elapsed in the charging cycle, real-time voltage, real-time current, real-time capacity (SoC, which is the real-time battery discharged status), real-time temperature, and cycle number of the battery 32. The voltage, current, SoC, temperature and cycle number can be collected either on the battery 32 as a whole, or collected individually for each battery cell 32a. It should be noted that the essential status required to determine the optimal charging current based on CCCM (as will be described in detail later) are the real-time SoC and the real-time voltage, which are part of the real-time charging profiles of the battery 32.

Before the adapting charging method based on on-site user inputs is performed, there is actually a choice provided to the user as shown in Step 41 in FIG. 3, that is whether the user wants to input on-site commands. This for example can be shown as a dialogue box on a display to prompt the user. If the user does not want to input any new commands for the charging, then the method as shown in FIG. 3 will not go to the right half portion (starting with Step 44) until the user is prompted with the question again at a later stage. Likewise, this means that the method flow as shown in FIG. 2 starting from Step 44 will not be carried out. Without a new charging target specified by the user (in the form of on-site commands), the charging system may charge the battery 32 using existing charging criteria such as those stored as default criteria or previously calculated criteria, and the method in FIG. 3 goes to Step 43 to determine if the charging has completed, for example by checking the real-time SoC. If the charging has not been completed, the method iterates between Steps 42 and Step 43. If the charging is completed, the cycle number of the battery 32 will be incremented.

In Step 41, if the user chooses to input on-site commands, then the method in FIG. 3 goes to Step 44 (while continuously carrying out Step 42). This means that the method in FIG. 2 also goes on at Step 44. In Step 44, the user provides on-site input commands to the MCU 24 via the user input device 20 that is connected to the MCU 24 via the communication link 21 as mentioned above. “On-site” herein refers to the scenario that the input commands on charging criteria are not embedded, factory-installed, or otherwise provided in advance. Rather, the user in Step 44 specifies the charging criteria in terms of a user available time in which the battery is to be charged (as expected by the user), and a target SoC to which the battery is to be charged. Effectively, the user's on-site inputs set a charging target. The charging criteria may take different values in different charging cycles, and in particular when the user is facing various charging scenarios. For example, if the user needs urgently to use the battery 32 and thus desires a quick charging, he/she will specify the user available time to be relatively short (e.g. one hour), and the target SoC is also not required to be 100% but a level that is sufficient for the user's urgent need. In contrast, if the user allows the charging time to be longer (e.g. overnight as the user will finish any work with the battery 32), then the user available time could be set to a larger value, and the target SoC is also larger in percentage or even be set to 100%. After the on-site input commands are obtained from the user in Step 44, the MCU 24 imports the CCCM for the battery 32 in Step 46 (see FIG. 2), in order to calculate an optimal charging current to the battery 32 at CC stage.

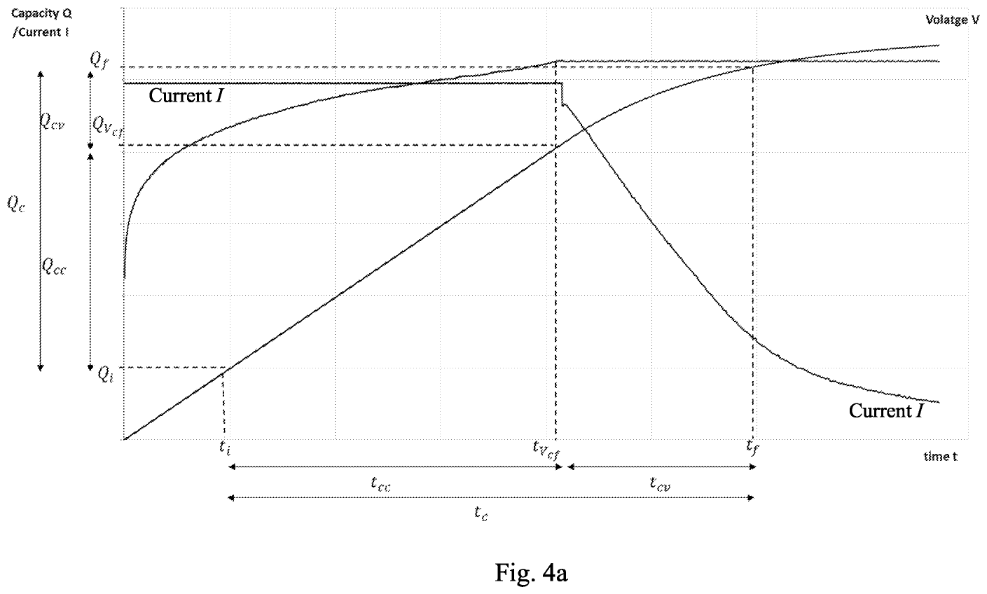

The capacity charging model CCCM is a programmable model that is specific to each battery, and can be self-calibrated by the battery charging system as the battery is being used. The creation and updating of the CCCM model involve modelling parameter relationship from charging profiles acquired from the battery. FIG. 4a illustrates in one example various charging profiles of a battery for constructing a CCCM for the battery, which are obtained through measurements to the battery (e.g., in a test condition or through normal use of the battery). The horizontal axis in FIG. 4a indicates the time elapsed in the current charging cycle of the battery, and it can be seen that whole charging cycle contains two phases, i.e., a CC mode with a time span of t_{cc} and a CV mode with a time span of t_{f}. In the CC mode which lasts from tᵢ to t_{Vcf}, the charging current I is made constant at I_{cc}, and one can see that the capacity Q (SoC) of the battery increases also from an initial value Qᵢ steadily in a linear manner. In this embodiment, Qᵢ refers to the initial capacity of charging or the battery's remaining capacity, and tᵢ is the corresponding time of Qᵢ in charging profiles. The charging profiles are described the battery capacity from 0% to 100%, but in practice, the charging is starting from Qᵢ. Thus, there is a need to introduce tᵢ to apply the charging profiles. The increased amount of capacity during the charging cycle Q_{c} is starting from Qᵢ and the charging period t_{c} is starting from tᵢ. For zero SoC, tᵢ is also zero. In the meantime, the charging voltage also increases but its increasing speed (i.e. the slope at any point in the curve) gradually decreases. When the voltage reaches the threshold value V_{cf} (i.e., cut-off voltage), the CC mode charging is terminated at t_{Vcf}, and the capacity is now at Q_{Vcf}. Next, the CV mode charging begins, and in this mode there is no more keeping of the current value. Instead, the voltage used for charging is kept at V_{cf}. As a result, the capacity Q in the CV mode still increases, but it is no longer a linear increase. Rather, the increasing speed of the capacity Q gradually decreases. In the meantime, the charging current I in the CV mode drops drastically, because the internal impedance of the battery increases when the SoC is approaching 100%. The CV mode charging terminates at t_{f} when the capacity Q reaches a threshold Q_{f} which can be set by the user (e.g., at 100% or any value below 100%, or it can be represented using an absolute capacity value such as Ah).

One can see from FIG. 4a that the increased amount of the capacity during the charging cycle Q_{c} is the sum of the increased amounts Q_{cc} and Q_{cv} respectively in the CC mode and CV mode. The total time required for the charging cycle, i.e., the charging period t_{c}, is the sum of the time t_{cc} and t_{cv} required respectively in the CC mode charging and CV mode charging. The general relationships between Q_{c}, t_{c}, V_{cf}, Qᵢ and I_{cc} will be described below.

In the CC mode voltage profile modeling:

$${Q}_{c c} = {I}_{c c} \cdot {t}_{c c} = {I}_{c c} ( {t}_{{V}_{cf}} - {t}_{i} )$$

$${t}_{i} = \frac{{Q}_{i}}{{I}_{c c}}$$

$${t}_{{V}_{c f}} = f ( {I}_{cc} , {V}_{c f} )$$

$${Q}_{c c} = {I}_{c c} \cdot {t}_{c c}$$

and therefore,

$${Q}_{c c} = {I}_{c c} ( ( {l}^{m . {V}_{c f} - n} - k ) - \frac{{Q}_{i}}{{I}_{c c}} ) \qquad ( Eq . 1 )$$

The t_{Vcf} can be obtained by considering voltage curve profiles under CC mode charging as follows.

$$\begin{matrix}{t}_{{V}_{c f}} = f ( {I}_{cc} , {V}_{c f} ) \\ = 60 ( {l}^{m . {V}_{c f} - n} - k )\end{matrix}$$

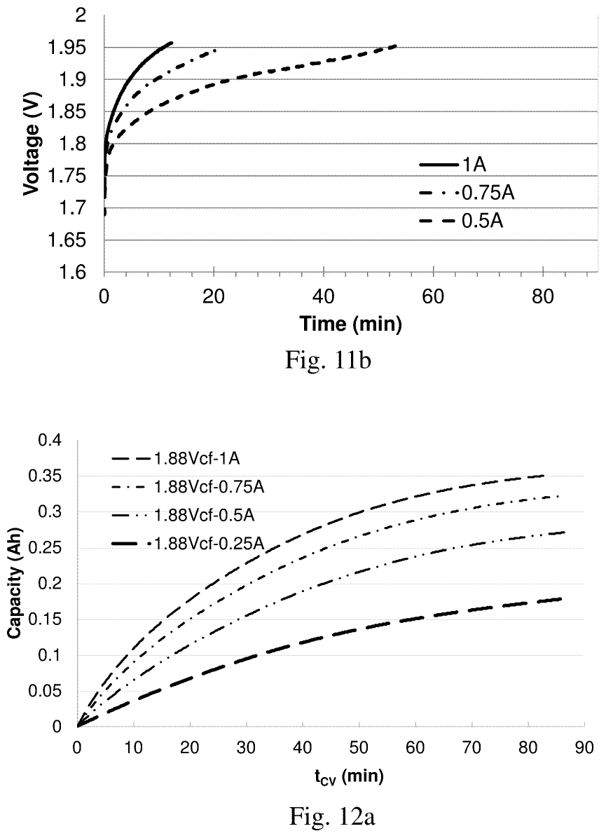

The values of CCCM parameters a, b, c, d, k, l, m and n can be determined by analyzing experimental data of charging profiles a particular battery. FIGS. 11a-11b show experiment data of an exemplary battery (aqueous Ni—Zn type) by measuring the voltage-time curves with different charging current and cut-off voltage V_{cf} settings. From the experimental data, l, m, n and k can be determined as follows:

l=−38.6056I³+92.952I²−73.998I+20.866

m=−227.768I³+501.12I²−227.52I+41.032

n=−445.92I³+997.72I²−455.5I+80.934

k=0.007356

On the other hand, in the CV mode capacity profile modeling:

t_{cv}=tᵢ+t_{c}−t_{V}_{_{cf}}.

Q_{cv}=f(t_{Vcf},I_{cc},V_{cf})

Q_{cv}=a·t_{cv}³+b·t_{cv}²+c·t_{cv}+d

and therefore,

$${Q}_{c v} = {a [ {t}_{c} - ( ( {l}^{m . {V}_{c f} - n} - k ) - \frac{{Q}_{i}}{{I}_{c c}} ) ]}^{3} + {b [ {t}_{c} - ( ( {l}^{m . {V}_{c f} - n} - k ) - \frac{{Q}_{i}}{{I}_{c c}} ) ]}^{2} + c [ {t}_{c} - ( ( {l}^{m . {V}_{c f} - n} - k ) - \frac{{Q}_{i}}{{I}_{c c}} ) ] + d \qquad ( Eq . 2 )$$

where a,b,c,d=f(I_{cc},V_{cf})

l,m,n=f(I_{cc})

The Q_{cv} can be obtained by considering capacity curve profiles under CV mode charging as follows.

$$\begin{matrix}{Q}_{c v} = f ( {t}_{{V}_{cf}} , {I}_{cc} , {V}_{c f} ) \\ = a . {t}_{c v}^{3} + b . {t}_{c v}^{2} + c . {t}_{c v} + d\end{matrix}$$

$${t}_{c v} = {t}_{c} - {t}_{{V}_{c f}} + \frac{{Q}_{i}}{{I}_{c c}}$$

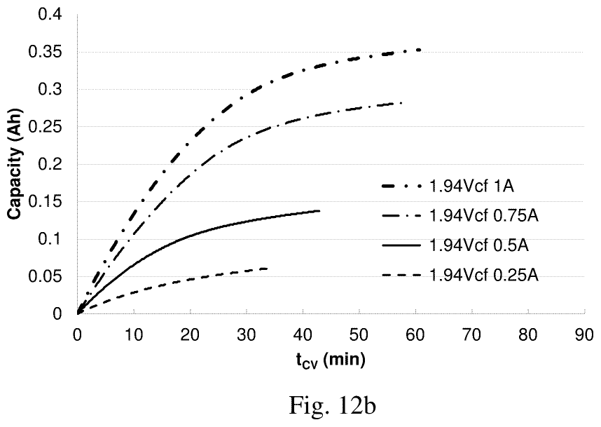

FIGS. 12a-12b show experiment data of an exemplary battery (aqueous Ni—Zn type) by measuring the capacity-time curves with different charging current and cut-off voltage V_{cf} settings. From the experimental data, a, b, c and d can be determined as follows:

a=(a₁I_{cc}+a₂)/60³ a₁=152.69V_{cf}²−583.87V_{cf}+558.15 a₂=3.7705V_{cf}−7.1165

b=(b₁I_{cc}+b₂)/60² b₁=−328.5V_{cf}²+1249.1V_{cf}−1187.7 b₂=84.812V_{cf}²−327.11V_{cf}+315.23

c=(c₁I_{cc}+c₂)/60 c₁=8.814V_{cf}−16.097 c₂=−2.5V_{cf}+4.845

d=d₁I_{cc}+d₂ d₁=−0.394V_{cf}+0.761 d₂=0.1075V_{cf}−0.2083

Based on the above derivations, after the CCCM parameters a, b, c, d, k, l, m and n are determined using historical, measured data of the battery, the CCCM model can be established based on Equation 1 and Equation 2 mentioned above which take into account of the set of CCCM parameters including a, b, c, d, k, l, m and n. The increased amount of the capacity during the charging cycle Q_{c} as a function of the CCCM parameters can be summarized as

$${Q}_{c} = {Q}_{c c} + {Q}_{c v}$$

$$= {\sum }_{{t}_{i}}^{{t}_{cf}} {I}_{cc} ( k , l , m , n ) + {\sum }_{{t}_{cf}^{c}}^{t} ( a , b , c , d ) ( k , l , m , n )$$

where CCCM parameters: a, b, c, d, k, l, m, n=f(I_{cc}, V_{cf})

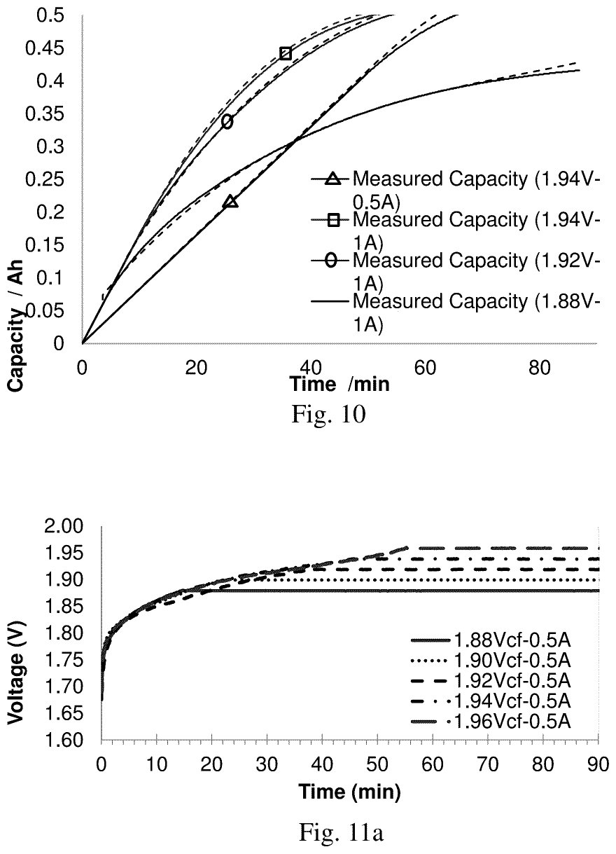

Consequently, using these equations, multiple correlations between capacity (Q) and charging time (t) can be obtained for different charging current (I). FIG. 4b shows examples of two capacity-time correlations for a battery at different charging currents, and for each charging current (1 A or 0.5 A), both a computed correlation (labeled “CCCM derive profile) using the CCCM model and a measured correlation by conducting real measurements to the battery with the charging current are provided. One can see that the curves for a given charging current between the computed correlation and the measured correlation quite accurately follow each other, which shows that the CCCM model has a high fidelity in representation the actual charging behavior of the battery, and so the CCCM model could help determine an optimal current based on user input commands. FIG. 10 shows the computed correlation and the measured correlation for the CCCM of another exemplary battery.

Back to FIGS. 2-3, after the user inputted the commands for a charging target that include at least the user available time and the target SoC as charging criteria in Step 44, and after the CCCM model is loaded in Step 46, the method proceeds to Step 48 in which the optimal charging current at the CC stage is calculated. The sub-routines of Step 48 is shown in FIG. 4c, in which one can see that the calculation of optimal current requires both the inputs of the user available time (i.e., charging period t_{c}) and the target SoC (Q_{c}), and the initial SoC of the battery 32 before the charging started. With these three input values, the MCU 24 is able to choose, from the multiple correlations stored in the CCCM model, a best correlation that meet both the user available time and the target SoC, on the basis of the initial SoC. Preferably, when there are more than one charging currents that meet the user available time and the target SoC, the MCU 24 will choose the smallest charging current because if the charging current is smaller, less deterioration to the battery cycle life will be caused. Using the two correlations shown in FIG. 4b for example, if the target SoC level corresponds to 0.3 Ah, and the user available time is 60 minutes, then apparently both the charging current of I=1 A and I=0.5 A satisfy the requirements. However, the smaller current of 0.5 A will be chosen as the optical charging current because it causes less deterioration to the battery cycle life.

After the optimal charging current is determined in Step 48, the MCU 24 in Step 49 sends corresponding charging command signals to the DC-DC converter 22 to stipulate the charging current outputted by the DC-DC converter 22 to the battery 32. The commands sent by the MCU 24 include those for different stages of charging, and as shown in FIG. 3 the commands include those for the CC mode charging, CV mode charging, and no charging (i.e., when charging is finished). As shown in FIG. 3, after the charging command signals are sent by the MCU 24, the method goes to Step 43 and similar to the case described above, the method iterates between Steps 42 and 43 until the battery 32 is charged to the target SoC within the required time (that is the user available time). If the charging is completed, the cycle number of the battery 32 will be incremented.

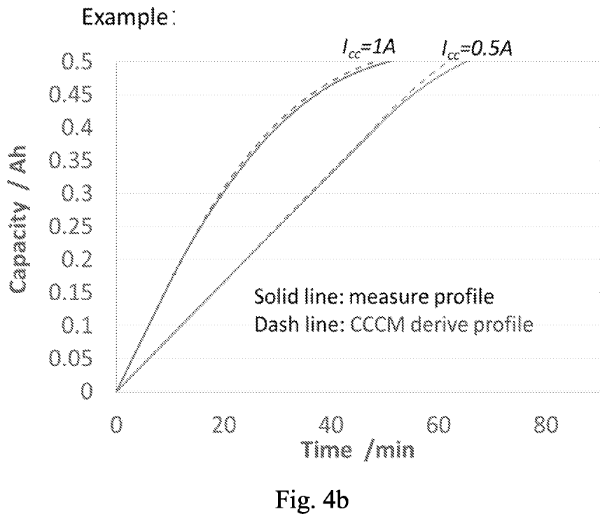

No matter if the charging of the battery 32 follows on-site user input commands or not, after it is determined in Step 43 that the charging is completed and thus the cycle number is incremented, the method goes to Step 45 in which the current cycle number is compared with predetermined thresholds of cycle numbers. The thresholds are each specified as the number of charging cycles that when a threshold is reached, the CCCM will need to be updated. For example, the thresholds can be set to numbers 10, 20, 30 . . . which means that after every ten charging cycles the CCCM needs to be updated. The user may adjust the interval between two adjacent thresholds as needed. Apparently, the smaller the interval is, the more frequent the CCCM will be updated, and in one example the interval can be set to one, which means that the CCCM is updated after each charging cycle is completed. If it is determined in Step 45 that a threshold is reached, then the method goes to Step 51 (see FIGS. 2-3) in which the CCCM is calibrated (by the MCU 24) using recent charging profiles under different CC stage charging currents on a periodic schedule. The recent charging profiles were recorded during charging periods in previous charging cycles, and the number of charging cycles from which the charging profiles are used to update the CCCM depends on the threshold of cycle numbers. The recent charging profiles includes those in the latest charging cycle (i.e., the latest charging cycle that has been recently completed), and also those from historical charging cycles earlier than the latest charging cycle. The recent charging profiles are stored in the memory of the MCU 24, and they are saved when a corresponding charging cycle is completed. Therefore, the recent charging profiles represent the actual, measured charging profiles obtained from the battery 32, and they facilitate the update of the CCCM so that the CCCM will be more accurately describing changed charging profiles of the battery 32 when the battery 32 has its internal condition changed as time goes by (e.g. deterioration due to normal use of the battery 32). FIG. 5 shows how the charging profile of an exemplary battery shifts (and in particular the time required to charge to a certain SoC becomes longer and longer).

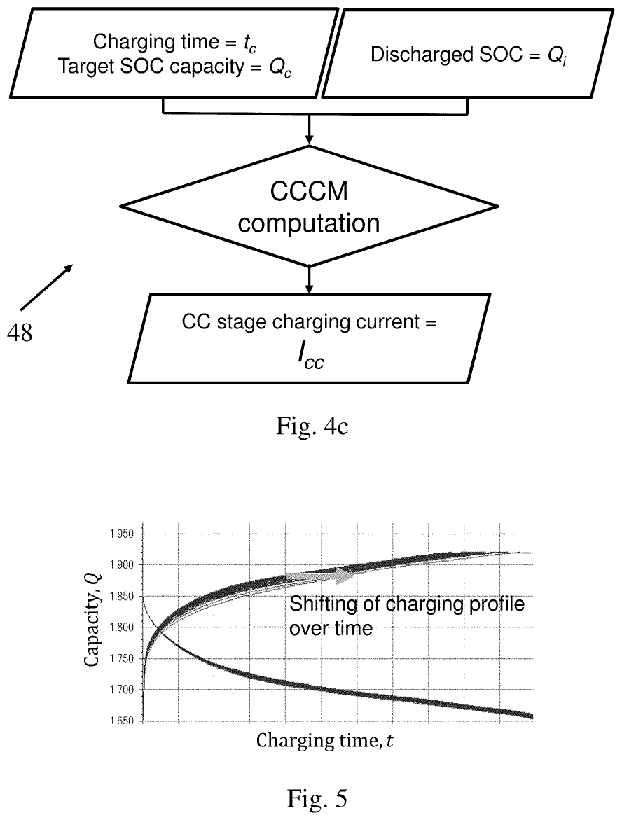

FIG. 6 shows an example method flow of updating the CCCM for a battery. The previous CCCM (i.e., before update) is used as the basis for update, and four charging cycles 60 have recently been conducted for the battery. For each of the charging cycles 60 the user specified on-site a charging target including the user available time tₘₐₓ, the target SoC Qₛₜₒₚ, which together with the initial SoC of the battery which is Qₛₜₐᵣₜ are all inputted into the CCCM of the battery. The outputs of the CCCM for each of the four charging cycles 60 is I_{cc} which as mentioned above is the optimal charging current in the CC stage. Although in FIG. 6 for each of the charging cycles 60 different designations (1, 2, 3, 4) of the time, SoC and charging current are used, but it does not mean that any of the corresponding parameters between two cycles 60 cannot be the same. Rather, in one example all parameters for the four charging cycles 60 could be exactly the same, and thus the optimal charging currents I₁, I₂, I₃ and I₄ are also the same.

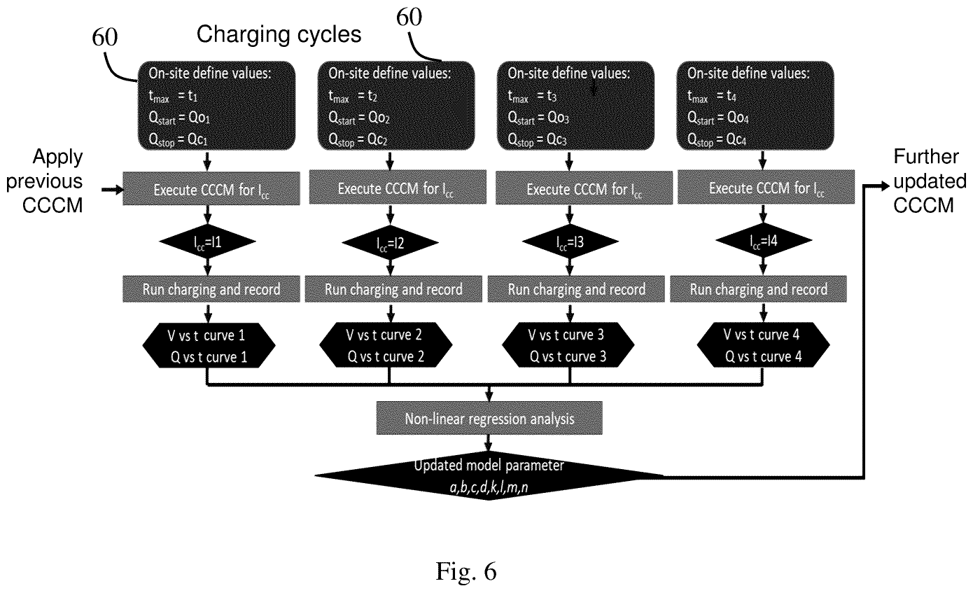

With the computed optimal charging currents I₁, I₂, I₃ and I₄ for each of the four charging cycles 60, the battery is charged, but at the same time the actual correlations between capacity and time as well as between voltage and time are recorded as recent charging profiles for each charging cycle 60. As a result, four curves 1-4 are obtained and stored in the memory of the MCU 24, and these curves represent the recent charging profiles. Next, the MCU 24 performs a non-linear regression analysis to the four curves/profiles, and the resultant capacity-time and voltage-time curves are used to determine the updated CCCM parameters, in a way similar to that mentioned above with reference to FIGS. 11a-12b. FIGS. 7a and 7b show examples of the updates in the curve of capacity-time and time-voltage, and the values of the sets of CCCM parameters a, b, c, d, k, l, m and n before and after the update. In this way, the CCCM will be updated regularly as the battery is utilized in its life span.

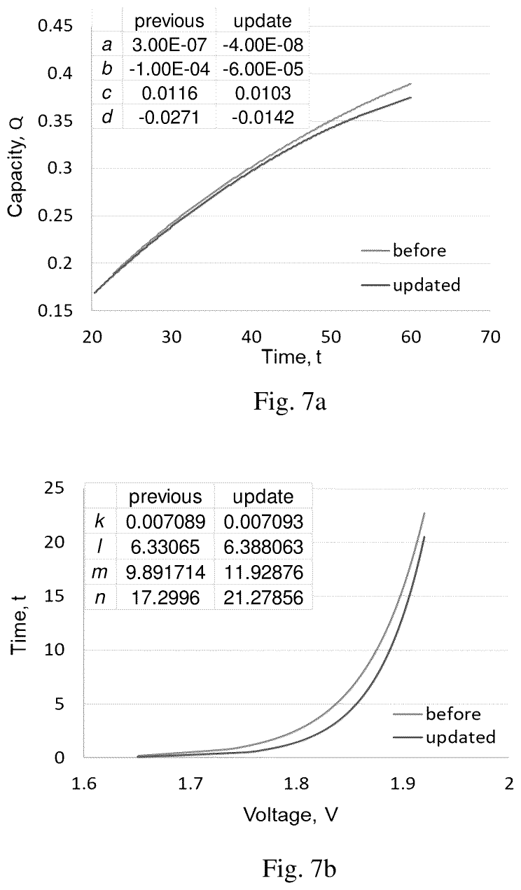

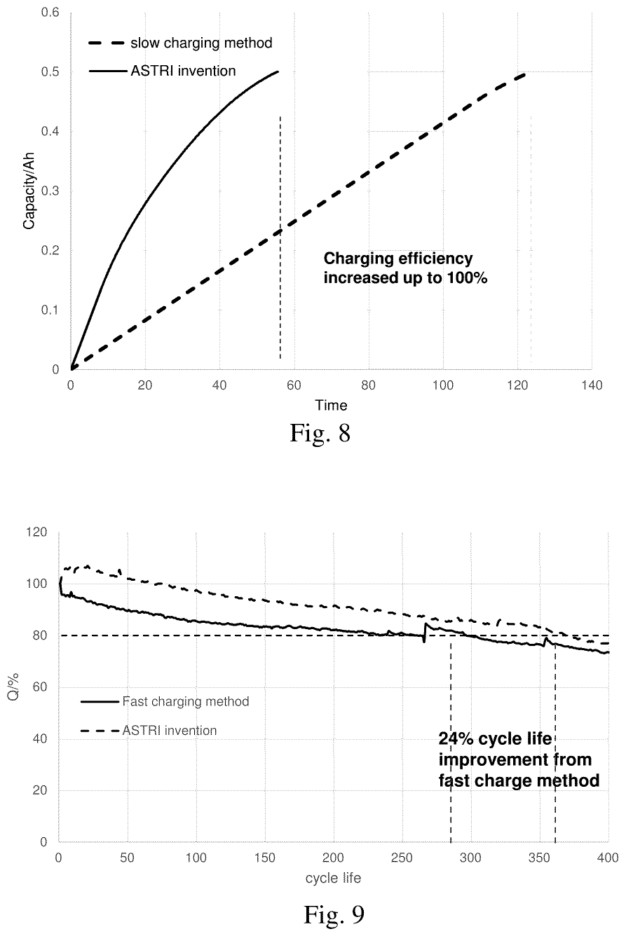

FIGS. 8-9 show respectively the comparison in charging efficiency between a method according to a preferred embodiment (designed as “ASTRI invention” in FIGS. 8-9) and a conventional slow-charging method, and the comparison in cycle life between the method according to the preferred embodiment and a conventional fast-charging method. The curves shown in the figures are measured by conducting tests to a battery in a laboratory environment. It can be seen from FIGS. 8-9 that compared to the conventional slow-charging method the charging efficiency increases up to 100% (which means that the charging time is saved up to 50%), and compared to the conventional fast-charging method the cycle life of the battery is improved by 24%. In other words, the method according to the preferred embodiment achieves a perfect balance between charging efficiency and battery cycle life, and there is no conventional charging method that can achieve similar optimal charging effect.

The exemplary embodiments are thus fully described. Although the description referred to particular embodiments, it will be clear to one skilled in the art that the invention may be practiced with variation of these specific details. Hence this invention should not be construed as limited to the embodiments set forth herein.

While the embodiments have been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

The functional units and modules of the systems and methods in accordance with the embodiments disclosed herein may be implemented using computing devices, computer processors, or electronic circuitries including but not limited to application-specific integrated circuits (ASIC), field programmable gate arrays (FPGA), and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure.

All or portions of the methods in accordance with the embodiments may be executed in one or more computing devices including server computers, personal computers, laptop computers, and mobile computing devices such as smartphones and tablet computers.

The embodiments include computer storage media, transient and non-transient memory devices having computer instructions or software codes stored therein which can be used to program computers or microprocessors to perform any of the processes of the present invention. The storage media, transient and non-transitory computer-readable storage medium can include but are not limited to floppy disks, optical discs, Blu-ray Disc, DVD, CD-ROMs, magneto-optical disks, ROMs, RAMs, flash memory devices, or any type of media or devices suitable for storing instructions, codes, and/or data.

Each of the functional units and modules in accordance with various embodiments also may be implemented in distributed computing environments and/or Cloud computing environments, wherein the whole or portions of machine instructions are executed in a distributed fashion by one or more processing devices interconnected by a communication network, such as an intranet, WAN, LAN, the Internet, and other forms of data transmission medium.

What is claimed is:

1. A method for charging a battery, comprising:
a) acquiring real-time information about the battery;
b) receiving an on-site input from a user, the on-site input comprising at least one of a user available time in which the battery is to be charged and a target State of Charge (SoC) to which the battery is to be charged;
c) by using a capacity charging model of the battery, calculating a charging current for the battery based on the on-site input and the real-time information;
d) charging the battery using the calculated charging current during a charging period; and
e) calibrating the capacity charging model based on information of the battery gathered during the charging period.

2. The method of claim 1, wherein the capacity charging model is a programmable model of the battery which is built based on a plurality of charging profiles of the battery.

3. The method of claim 2, wherein the plurality of charging profiles of the battery comprise a constant voltage (CV) mode capacity profile, and a constant current (CC) mode voltage profile.

4. The method of claim 3, wherein in the capacity charging model, the CC mode capacity profile is ahead of the CV mode voltage profile in time.

5. The method of claim 2, wherein the capacity charging model comprises a plurality of capacity-time correlations each defined under a condition including a CC mode current and a CV mode voltage;

6. The method of claim 5, wherein the plurality of capacity-time correlations is described by a set of parameters that are derived from the plurality of charging profiles of the battery.

7. The method of claim 1, wherein Step a) further comprises recording the following information of the battery: real-time SoC and real-time voltage.

8. The method of claim 1, wherein the charging current is for a CC charging stage of the battery according to the on-site input; Step c) further comprising steps of:
f) identifying, from a plurality of capacity-time correlations in the capacity charging model, an optimal correlation that meets the user available time and/or the target SoC; and
g) choosing an optimal current that is associated with the optimal correlation, as the charging current.

9. The method of claim 1, wherein each one of the plurality of capacity-time correlations is further associated with a charging voltage for a CV charging stage of the battery.

10. The method of claim 1, wherein Step e) further comprises steps of:
h) recalling, from a memory device, one or more recent charging profiles which are associated with recent charging cycles and stored in the memory device;
i) conducting an analysis to the one or more recent charging profiles to identify a set of updated parameters for the capacity charging model; and
j) calibrating the capacity charging model using the set of updated parameters.

11. The method of claim 10, wherein the one or more recent charging profiles comprises latest charging profiles of the battery gathered during the charging period which are stored to the memory device after Step d).

12. The method of claim 11, wherein the one or more recent charging profiles further comprises previous charging profiles of the battery gathered during charging periods associated with previous charging cycles of the battery.

13. The method of claim 10, wherein the analysis comprises a non-linear regression analysis.

14. A system for charging a battery, comprising:
a) one or more processors;
b) a battery charging circuit connected to the one or more processors; the battery charging circuit adapted to connect to the battery;
c) a user inputting means connected to the one or more processors, and
d) a memory storing computer-executable instructions that, when executed, cause the one or more processors to
i) acquiring real-time information about the battery;
ii) receiving on-site input from a user via the user inputting means, the on-site input comprising at least one of a user available time in which the battery is to be charged and a target State of Charge (SoC) to which the battery is to be charged;
iii) by using a capacity charging model of the battery, calculating a charging current for the battery based on the on-site input and the real-time information;
iv) charging the battery by controlling the battery charging unit to use the calculated charging current during a charging period; and
v) calibrating the capacity charging model based on information of the battery gathered during the charging period.

15. A non-transitory computer readable medium, comprising executable instructions that, when executed by at least one processor, direct the at least one processor to perform a method, the method comprising:
a) acquiring real-time information about a battery;
b) receiving on-site input from a user, the on-site input comprising at least one of a user available time in which the battery is to be charged and a target State of Charge (SoC) to which the battery is to be charged;
c) by using a capacity charging model of the battery, calculating a charging current for the battery based on the on-site input and the real-time information;
d) controlling a battery charging circuit to charge the battery using the calculated charging current during a charging period; and
e) calibrating the capacity charging model based on information of the battery gathered during the charging period.
